(19) United States
(12) Patent Application Publication
(10) Pub. No.: US 2003/0184993 A1
(43) Pub. Date: Oct. 2, 2003

(54) Backlight and liquid crystal display device employing it

(76) Inventor: Katsuaki Yamada, Kashihara-Shi (JP)

Correspondence Address: NIXON & VANDERHYE, PC, 1100 N GLEBE ROAD, 8TH FLOOR, ARLINGTON, VA, 22201-4714, US

(21) Appl. No.: 10/393,282

(22) Filed: Mar. 21, 2003

(30) Foreign Application Priority Data
Mar. 26, 2002 (JP) 2002-084952
Feb. 20, 2003 (JP) 2003-042128

(51) Int. Cl. F21V 7/04

(52) U.S. Cl. 362/31

(57) ABSTRACT

A liquid crystal display device 1 having a direct-lit backlight 3 disposed immediately below a liquid crystal panel 2 for illuminating the liquid crystal panel 2 has a plurality of tubular light sources 4 disposed at predetermined intervals, a reflector sheet 5 for reflecting the light from the light source 4 to guide it to an illuminated member, a substrate 8 disposed between the light source 4 and the liquid crystal panel 2 and having a lens array 8a, and a diffusive sheet disposed between the substrate 8 and the liquid crystal panel 2 and formed of a diffusive material.

### BACKGROUND OF THE INVENTION

1. Field of the Invention

The present invention relates to a backlight of the direct-lit type that achieves illumination of a display device, such as a liquid crystal panel, by the use of a light source arranged face to face with the display device, and relates also to a liquid crystal display device employing such a backlight.

2. Description of the Prior Art

A liquid crystal display device forms an image by illuminating a liquid crystal panel by means of a backlight arranged on the back side of the liquid crystal panel. Small-size liquid crystal display devices for use in car navigation systems, notebook personal computers, and the like employ a side-lit backlight that uses a light guide plate. This backlight has the light guide plate arranged face to face with a liquid crystal panel so that the light emanating from a light source, such as a fluorescent lamp, arranged on one or more edges of the light guide plate is guided through the light guide plate to the liquid crystal panel so as to illuminate it.

However, large-size liquid crystal display devices for use in 20-inch or larger monitor displays have a large area to be illuminated, and thus require an increased number of fluorescent tubes to achieve satisfactory brightness. Arranging a number of fluorescent tubes on edges of a light guide plate results in a marked rise in temperature at the edges of the light guide plate, leading to lower illumination efficiency. For this reason, large-size liquid crystal display devices employ a direct-lit backlight having a plurality of fluorescent tubes arranged parallel to and face to face with a liquid crystal panel.

FIG. 21 is a side view showing an outline of a liquid crystal display device having a conventional direct-lit backlight. The liquid crystal display device 1 is composed of a liquid crystal panel 2 and a backlight 3 arranged on the back side thereof. The backlight 3 includes a light source 4, a reflector sheet 5, a diffuser plate 6, and a diffuser sheet 7. The light source 4 is composed of a plurality of tubular fluorescent tubes 4a arranged at predetermined intervals. The reflector sheet 5 is arranged on the back side of the light source 4, and serves to reflect the light from the light source 4 so as to guide it to the liquid crystal panel 2.

The diffuser plate 6 is formed of a diffusive material, such as an opaque resin, and serves to transmit the light from the light source 4 while diffusing it. The diffuser plate 6 evenly incorporates a light-shielding material 6a with low transmittance, such as barium sulfate or titanium oxide. The diffuser plate 6 has light-shielding dots (not shown) printed in a portion thereof facing the light source 4. This helps reduce the amount of light transmitted and thereby give the light from the light source 4 an even brightness distribution. The diffuser sheet 7 is formed of a translucent resin sheet incorporating a diffusive material, and serves to further diffuse the light transmitted through the diffuser plate 6.

FIGS. 22, 23, and 24 show the brightness distribution of the light emitted from the backlight 3, with the diffuser sheet 7 removed, with one type of diffuser sheet 7 laid, and with another type of diffuser sheet 7 laid, respectively. Along the vertical axis is taken the brightness ratio (in %), and along the horizontal axis is taken the position (in mm) in the direction in which the fluorescent tubes 4a are arranged at intervals.

Here, the liquid crystal panel 2 has a 20-inch size, and the backlight 3 is accordingly sized, with eight fluorescent tubes 4a (manufactured by Stanley Electric Co., Ltd., Japan, with an external diameter 26 mm) arranged at intervals “a”=38 mm. Used as the reflector sheet 5 is Lumirror™ E60L, manufactured by Toray Industries Inc., Japan, arranged at a distance “b”=16 mm from the diffuser plate 6.

In FIG. 23, used as the diffuser sheet 7 is Light UP™ 100 PBS, manufactured by Kimoto & Co., Ltd., Japan. In FIG. 24, used as the diffuser sheet 7 is the same sheet as used in FIG. 23 but having Opalus™ 100-KBS II, manufactured by Keiwa Shoko Co., Ltd., Japan, laid on top thereof.

These diagrams show that, while omitting the diffuser sheet 7 (FIG. 22) results in unacceptably uneven brightness at the intervals at which the fluorescent tubes 4a are arranged, laying the diffuser sheet 7 helps alleviate uneven brightness (FIGS. 23 and 24). This helps enhance the viewability of the image displayed on the liquid crystal panel 2.

However, in the liquid crystal display device 1 described above, since the diffuser plate 6 is opaque, the light passing therethrough is repeatedly reflected and refracted by particles incorporated in the diffuser plate 6, and this attenuates the intensity of the light. Moreover, the light-shielding print shields part of the light, and thus lowers overall brightness. These factors lower the illumination efficiency of the backlight 3. Furthermore, since the light-shielding print is formed at predetermined intervals, when observed from an oblique direction, the light-shielding print is located off the fluorescent tubes 4a, causing uneven brightness.

Japanese Patent Applications Laid-Open Nos. 2001-202814, H5-333333, and H6-250178 disclose backlights provided with, instead of a diffuser plate 6, a prism plate having prisms with a predetermined vertex angle formed at predetermined intervals. Here, the light from a light source is diffused by being refracted by the prisms. This helps minimize the loss of transmitted light and thereby increase the brightness of the emitted light.

Japanese Patent Application Laid-Open No. H5-61043 discloses a backlight having a Fresnel lens disposed on one side of a light source and having a reflector plate with a paraboloid surface disposed on the opposite side of the light source. Here, the light source is arranged at the focal point of the reflector plate so that the light traveling directly from the light source and the light reflected as a parallel beam from the reflector plate is condensed into a predetermined range of angles. This makes it possible to diffuse the light from the light source while minimizing the loss of transmitted light and thereby increase the brightness of the emitted light.

Japanese Patent Application Laid-Open No. 2001-35223 discloses a side-lit backlight having a light source arranged on an edge of a light guide plate arranged face to face with a member to be illuminated. Here, the backlight has a lenticular sheet, having an array of lenticular lenses or the like, disposed between the light guide plate and the to-be-illuminated member. This lenticular sheet makes it possible to diffuse the light from the light source while minimizing the loss of transmitted light and thereby increase the brightness of the emitted light.

However, in the backlights disclosed in Japanese Patent Applications Laid-Open Nos.2001-202814, H5-333333, and H6-250178 mentioned above, when observed from an oblique direction, the light from the light source exits from the prisms without being refracted. Thus, here, no improvement can be made on the uneven brightness observed from an oblique direction.

In the backlight disclosed in Japanese Patent Application Laid-Open No. H5-61043 mentioned above, when a plurality of light sources are used to illuminate a large-size liquid crystal display device, it is necessary to use a reflector plate and a Fresnel lens with each of the light source. This complicates the shapes of the reflector plates and the Fresnel lenses.

In the backlight disclosed in Japanese Patent Application Laid-Open No. 2001-35223 mentioned above, since the light from the light source is guided through the light guide plate, the lens sheet and the light guide plate are arranged with an air gap secured in between. Thus, the light passing through the light guide plate is inevitably refracted and reflected at the interface between the light guide plate and the air gap and at the interface between the air gap and the lens sheet. This attenuates the intensity of the light and thus lowers illumination efficiency.

### SUMMARY OF THE INVENTION

An object of the present invention is to provide a backlight and a liquid crystal display device that offer increased illumination efficiency in combination with reduced unevenness in brightness when observed from an oblique direction.

To achieve the above object, according to one aspect of the present invention, a backlight is provided with a light source arranged face to face with an illuminated member, a translucent substrate disposed between the light source and the illuminated member and having a lens array, and a diffusive sheet disposed between the substrate and the illuminated member for diffusing light.

In this structure, illumination light emanates from the light source, which is composed of, for example, a plurality of fluorescent tubes arranged side by side. The illumination light is transmitted through the translucent substrate, is then condensed by the lens array at the intervals at which it has its lenses arranged, and is then diffused. The illumination light is then further diffused by the diffusive sheet before being shone on the illuminated member. The lens array has lenses having curves surfaces, such as hemispherical lenses, lenticular lenses, or ball lenses, formed in an array at predetermined intervals, which may be regular or irregular.

In the backlight structured as described above, the diffusive sheet may have a haze value of 70% or higher.

In the backlight structured as described above, the lens array may have lenticular lenses or hemispherical lenses arranged in an array. This structure permits the lens array to be formed integrally by molding.

In the backlight structured as described above, the lens array may be formed on the surface of the substrate facing the illuminated member, with the surface of the substrate facing the light source formed matte. In this structure, when light enters the translucent substrate, it is diffused by the matte surface.

In the backlight structured as described above, the lens array may be formed on both surfaces of the substrate. In this structure, when light enters the translucent substrate, it is diffused by the lens array.

In the backlight structured as described above, the substrate may be 1 mm or more thick.

According to another aspect of the present invention, a liquid crystal display device has the backlight structured as described above arranged with the light source thereof located face to face with the light-receiving surface of a liquid crystal panel serving as the illuminated member.

### BRIEF DESCRIPTION OF THE DRAWINGS

This and other objects and features of the present invention will become clear from the following description, taken in conjunction with the preferred embodiments with reference to the accompanying drawings in which:

FIG. 1 a side view showing an outline of the liquid crystal display device of a first embodiment of the invention;

FIG. 2 is a perspective view showing the substrate of the backlight of the liquid crystal display device of the first embodiment;

FIG. 3 is a back-side perspective view showing the substrate of the backlight of the liquid crystal display device of the first embodiment;

FIG. 4 is a perspective view showing the light passing through the backlight of the liquid crystal display device of the first embodiment;

FIG. 5 is a detail view of a principal portion of the lens array of the backlight of the liquid crystal display device of the first embodiment;

FIG. 6 is a detail view of a principal portion of the lens array of the backlight of the liquid crystal display device of the first embodiment;

FIG. 7 is a perspective view showing the substrate of the backlight of the liquid crystal display device of a second embodiment of the invention;

FIG. 8 is a detail view of a principal portion of the lens array of the backlight of the liquid crystal display device of a third embodiment of the invention;

FIG. 9 is a detail view of a principal portion of the lens array of the backlight of the liquid crystal display device of the third embodiment;

FIG. 10 is a detail view of a principal portion of the lens array of the backlight of the liquid crystal display device of a fourth embodiment of the invention;

FIG. 11 is a back-side perspective view showing the substrate of the backlight of the liquid crystal display device of a fifth embodiment of the invention;

FIG. 12 is a diagram showing the brightness distribution of the light emanating from the light source of the backlight of the liquid crystal display device of the first embodiment;

FIG. 13 is a diagram showing the brightness distribution of the light exiting from the substrate of the backlight of the liquid crystal display device of the first embodiment;

FIG. 14 is a diagram showing the brightness distribution of the light exiting from the diffusive sheet of the backlight of the liquid crystal display device of the first embodiment;

FIG. 15 is a diagram showing the brightness distribution of the light exiting from the diffusive sheet of the backlight of the liquid crystal display device of the first embodiment;

FIG. 16 is a diagram showing the brightness distribution of the light exiting obliquely from the diffusive sheet of the backlight of the liquid crystal display device of the first embodiment;

FIG. 17 is a diagram showing the brightness distribution of the light exiting obliquely from the diffusive sheet of the backlight of the liquid crystal display device of the first embodiment;

FIG. 18 is a plan view showing another example of the light source of the liquid crystal display device of the first embodiment;

FIG. 19 is a plan view showing another example of the light source of the liquid crystal display device of the first embodiment;

FIG. 20 is a plan view showing another example of the light source of the liquid crystal display device of the first embodiment;

FIG. 21 is a side view showing an outline of a conventional liquid crystal display device;

FIG. 22 is a diagram showing the brightness distribution of the light exiting from the substrate of a conventional liquid crystal display device;

FIG. 23 is a diagram showing the brightness distribution of the light exiting from the diffusive sheet of a conventional liquid crystal display device; and

FIG. 24 is a diagram showing the brightness distribution of the light exiting from the diffusive sheet of a conventional liquid crystal display device.

### DESCRIPTION OF THE PREFERRED EMBODIMENTS

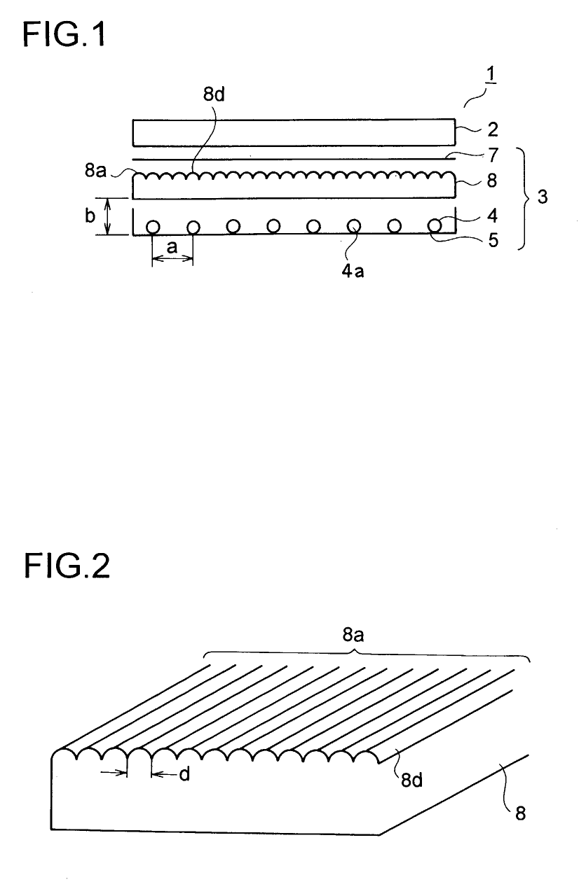

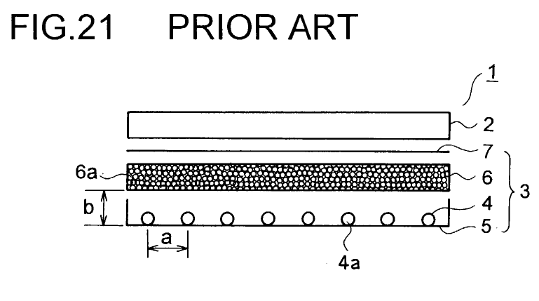

Hereinafter, embodiments of the present invention will be described with reference to the drawings. For convenience' sake, in the following descriptions, such components as are found also in the conventional example shown in FIG. 21 are identified with the same reference numerals. FIG. 1 a side view showing an outline of the liquid crystal display device of a first embodiment of the invention. The liquid crystal display device 1 is composed of a liquid crystal panel 2 and a backlight 3 arranged on the back side thereof The liquid crystal panel 2 has liquid crystal sealed between pixel electrodes, arranged in a matrix-like formation, and an opposing electrode, arranged so as to face the pixel electrodes. When a voltage is applied between particular pixel electrodes and the opposing electrode, the liquid crystal transmits light there to display an image.

The backlight 3 includes a light source 4, a reflector sheet 5, a substrate 8, and a diffuser sheet 7. The light source 4 is composed of a plurality of tubular fluorescent tubes 4a arranged at predetermined intervals. The reflector sheet 5 is arranged on the back side of the light source 4, and serves to reflect the light from the light source 4 so as to guide it to the liquid crystal panel 2.

The substrate 8 is a plate-shaped, translucent member formed of transparent glass, resin, or the like. The substrate 8 does not deform, and thus can easily be built into the backlight 3. The substrate 8 has a lens array 8a formed on the surface thereof facing the liquid crystal panel 2. FIG. 2 is a perspective view of the substrate 8. The lens array 8a is composed of a plurality of lenticular lenses 8d, each having a cylindrical surface extending in the length direction of the fluorescent tubes 4a, arranged at predetermined intervals “d.” The substrate 8 having the lenticular lenses 8d can easily be formed by molding.

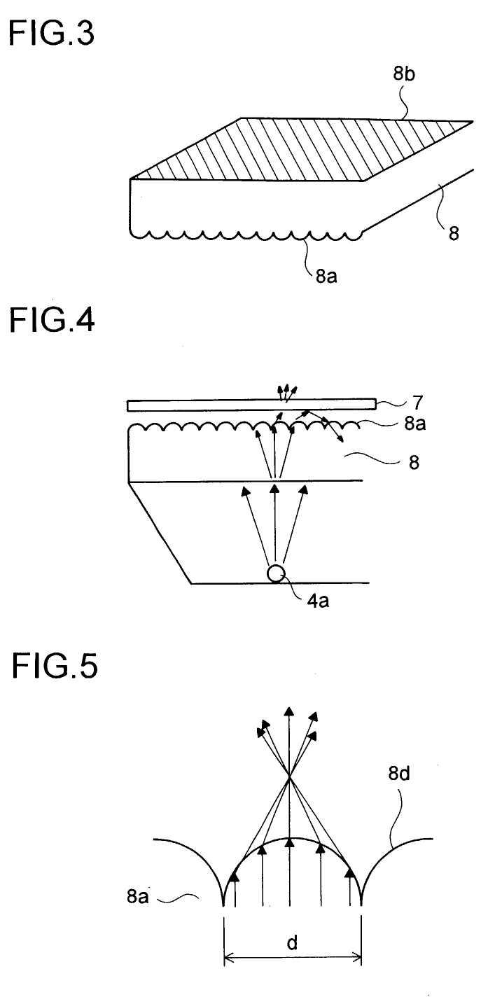

Moreover, as shown in FIG. 3, the back surface of the substrate 8 is formed as a matte surface 8b like ground glass so as to diffuse the light incident thereon. The matte surface 8b is formed by graining, sand blasting, or the like. The diffuser sheet 7 is formed of a translucent resin sheet incorporating a diffusive material, and serves to diffuse the light transmitted through the substrate 8.

In the liquid crystal display device 1 structured as described above, as shown in FIG. 4, the light emanating from the light source 4 (fluorescent tubes 4a) is, together with the light reflected from the reflector sheet 5 (see FIG. 1), incident on the substrate 8. The light is diffused by the matte surface 8b (see FIG. 3) of the substrate 8, and then exits from the substrate 8 through the lens array 8a so as to be condensed at the intervals “d” as shown in FIG. 5. The condensed light then further travels forward while diverging, is then further diffused by the diffuser sheet 7, and then illuminates the liquid crystal panel 2.

Thus, the disuse of the conventionally used diffuser plate 6 (see FIG. 21) helps minimize the attenuation of light intensity resulting from light being repeatedly reflected and refracted by particles incorporated in the diffuser plate 6. Moreover, it is possible to avoid lowering of brightness ascribable to a light-shielding print. Accordingly, it is possible to increase the illumination efficiency of the backlight 3. Moreover, since the lens array 8a is formed integrally with the substrate 8, it is possible to minimize the occurrence of refraction and reflection and thereby alleviate the attenuation of light intensity.

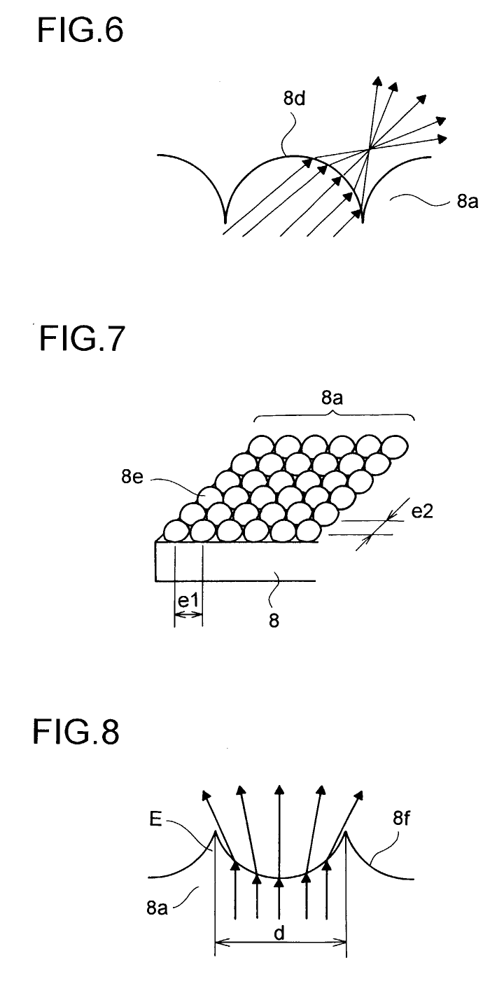

Moreover, as shown in FIG. 6, light obliquely incident on the substrate 8 is condensed at the intervals “d” by the lens array 8a, and then travels obliquely forward while diverging. Thus, even when the liquid crystal display device 1 is viewed from an oblique direction, it is possible to observe the image on the liquid crystal panel 2 illuminated by the light diffused by the lens array 8a and the diffuser sheet 7. This helps prevent uneven brightness.

Here, since the substrate 8 is transparent, the light having passed therethrough has more uneven brightness than that having passed through an opaque diffuser plate 6 (see FIG. 21) incorporating diffusive particles. However, the provision of the diffuser sheet 7 permits part of the light exiting from the substrate 8 to be reflected from the back surface of the diffuser sheet 7, the diffusive material incorporated therein, or the like to enter the substrate 8 again. This light, by being refracted in the substrate 8 or reflected from the reflector sheet 5, exits from the substrate 8 again from locations different from those from which it exited formerly.

The light that has entered the conventional diffuser plate 6 (see FIG. 21) again is repeatedly reflected and refracted by the particles incorporated therein. This attenuates the intensity of the light, and thus permits only a small portion of the light to exit from the diffuser plate 6 again. By contrast, the provision of the substrate 8 and the diffuser sheet 7 produces diffusion by the diffuser sheet 7 and diffusion resulting from re-exiting from the substrate 8. This helps alleviate uneven brightness more effectively than conventionally achieved. Here, however, if the diffuser sheet 7 is insufficiently diffusive, even with the help of re-exiting, there occurs more uneven brightness than conventionally observed. When the diffuser sheet 7 has a haze value of 70% or higher, it is possible to alleviate uneven brightness more effectively than conventionally achieved.

It is preferable that the substrate 8, a plate-shaped member, be made 1 mm or more thick. This permits the light from the light source 4 to reach the diffuser sheet 7 as sufficiently radiating light. Moreover, the light that has been reflected from the diffuser sheet 7 and has entered the substrate 8 again is guided to locations away from those from which it exited from the substrate 8 formerly. This helps secure distances between original exit locations and re-exit locations, and thus helps more effectively diffuse the light emitted from the liquid crystal display device 1.

FIG. 7 is a perspective view showing the substrate of the liquid crystal display device of a second embodiment of the invention. For convenience' sake, such components as are found also in the first embodiment shown in FIGS. 1 to 3 described above are identified with the same reference numerals. This embodiment differs from the first embodiment in that the lens array 8a has, by molding or the like, a plurality of hemispherical lenses 8e arranged in a square grid-like formation at predetermined intervals “e1” and “e2” in mutually perpendicular directions. In other respects, this embodiment is the same as the first embodiment.

In this embodiment, the light exiting from the substrate 8 is condensed at the intervals “e1” and “e2” by the hemispherical lenses, and then travels forward while diverging. Thus, the same goal is achieved as in the first embodiment. The hemispherical lenses 8e may be arranged in a triangular grid-like formation, or may be arranged at irregular intervals.

FIG. 8 is a detail view showing a principal portion of the lens array of the substrate of the liquid crystal display device of a third embodiment of the invention. For convenience' sake, such components as are found also in the first embodiment shown in FIGS. 1 to 3 described above are identified with the same reference numerals. This embodiment differs from the first embodiment in that the lens array 8a has a plurality of concave lenses 8f, each having a cylindrical surface extending in the length direction of the fluorescent tubes 4a (see FIG. 1), arranged at predetermined intervals “d.” In other respects, this embodiment is the same as the first embodiment.

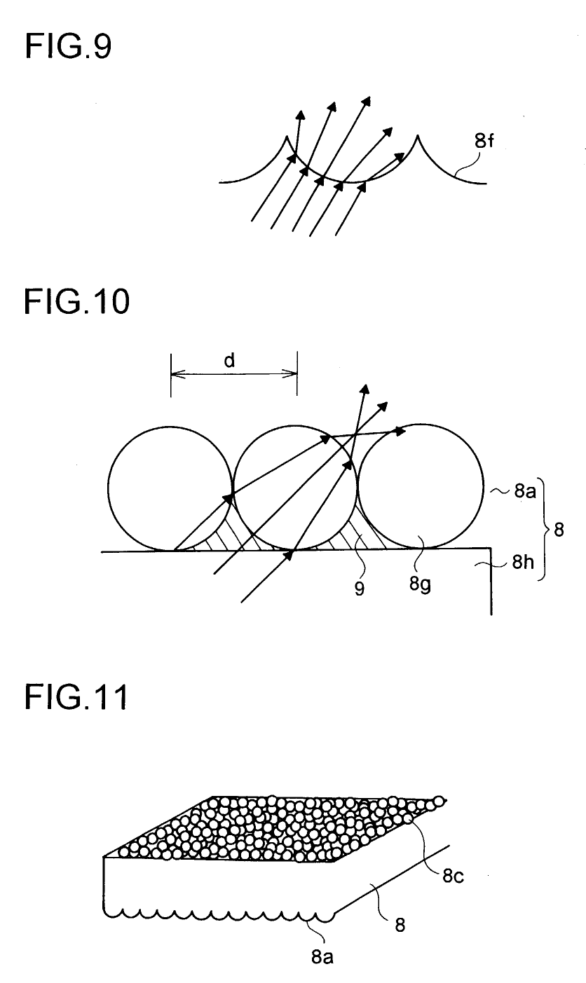

In this embodiment, the light exiting from the substrate 8 is made to diverge at the intervals “d” by the concave lenses 8f Moreover, as shown in FIG. 9, light obliquely incident on the substrate 8 is also made to diverge by the concave lenses 8f in a similar manner. Thus, the same goal is achieved as in the first embodiment. In this embodiment, the projections E (see FIG. 8) at the boundaries between the concave lenses 8f are sharp, and are thus prone to deformation under heat and by scratching. For this reason, from the viewpoint of avoiding such deformation, the first and second embodiments are preferable, in which the projections have smooth curved surfaces.

FIG. 10 is a detail view showing a principal portion of the lens array of the substrate of the liquid crystal display device of a fourth embodiment of the invention. For convenience' sake, such components as are found also in the first embodiment shown in FIGS. 1 to 3 described above are identified with the same reference numerals. This embodiment differs from the first embodiment in that the substrate 8 has a plurality of ball lenses 8g, which are transparent beads, arranged on top of a substrate 8h formed of transparent glass, resin, or the like. The ball lenses 8g are bonded firmly to the substrate 8h with adhesive 9 to form the lens array 8a. The adhesive 9 is made of a transparent UV-setting resin or the like, and has an index of refraction roughly equal to that of the ball lenses 8g. In other respects, this embodiment is the same as the first embodiment.

In this embodiment, the light exiting from the substrate 8 is condensed at the intervals “d” by the ball lenses 8g, and then travels forward while diverging. Moreover, light obliquely incident on the substrate 8 is also condensed by the ball lenses 8g in a similar manner, and then travels forward while diverging. Thus, the same goal is achieved as in the first embodiment.

The ball lenses 8g may be arranged irregularly, or may even be sprayed so as to overlap one another. This embodiment requires an additional step of bonding the ball lenses 8g. For this reason, from the viewpoint of reducing the number of fabrication steps, the first and second embodiments are preferable, in which the substrate 8 can be formed easily by molding.

FIG. 11 is a back-side perspective view showing the substrate of the liquid crystal display device of a fifth embodiment of the invention. For convenience' sake, such components as are found also in the first embodiment shown in FIGS. 1 to 3 described above are identified with the same reference numerals. This embodiment differs from the first embodiment in that the substrate 8 has a plurality of ball lenses 8c, which are transparent spherical beads formed of glass, resin, or the like, sprayed on the back surface thereof. The ball lenses 8c are bonded firmly to the substrate 8 to form a lens array. In other respects, this embodiment is the same as the first embodiment.

In this embodiment, light incident on the substrate 8 is refracted and thereby condensed by the lens array formed by the ball lenses 8c, is then condensed by the lens array 8a formed on the surface of the substrate 8 facing the diffuser sheet 7 (see FIG. 1), and then travels forward while diverging. Thus, the same goal is achieved as in the first embodiment. It is also possible to spray ball lenses 8c on the back surface of the substrate 8 in a similar manner in the second to fourth embodiments. It is also possible to arrange lenticular lenses or hemispherical lenses on the back surface of the substrate 8.

In the first to fifth embodiments, the lens array 8a is provided on the surface of the substrate 8 facing the liquid crystal panel 2. However, the lens array 8a may be provided on the surface of the substrate 8 facing the light source 4, or on both surfaces of the substrate 8 as in the fourth embodiments. In the embodiments, the liquid crystal panel 2 is illuminated by the backlight 3. However, a similar backlight 3 may be used in any other type of display apparatus for illuminating an outdoor commercial signboard, an X-ray photograph, or the like.

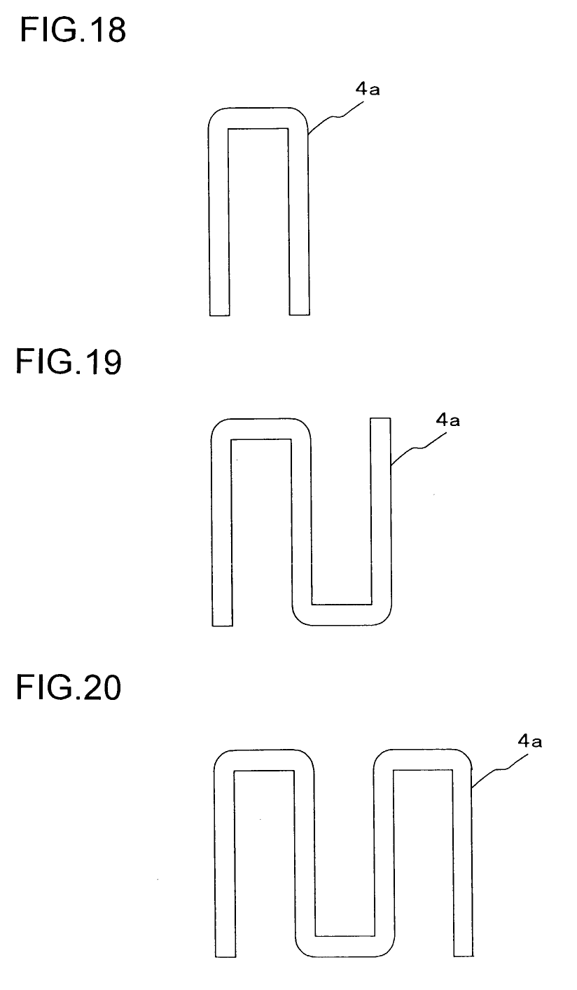

Here, the light source 4 is composed of a plurality of straight fluorescent tubes 4a arranged side by side. However, the light source 4 may be formed by bending a straight fluorescent tube 4a into a C-like shape at one or more locations as shown in FIGS. 18, 19, and 20.

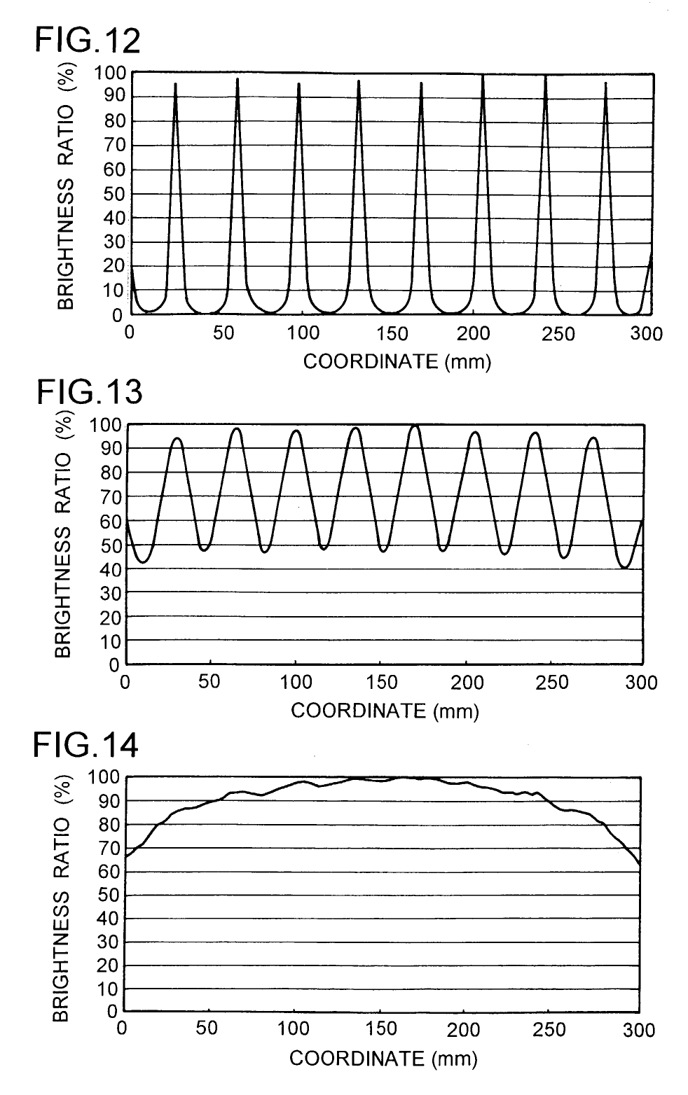

Hereinafter, a practical example of the present invention will be presented. FIGS. 12 to 17 are diagrams illustrating the brightness distribution observed in the liquid crystal display device 1 of the first embodiment shown in FIG. 1 described earlier. FIG. 12 shows the brightness distribution of the light emanating from the light source 4, with the reflector sheet 5 laid. FIG. 13 shows the brightness distribution of the same light emanating from the light source 4, with the substrate 8 additionally laid.

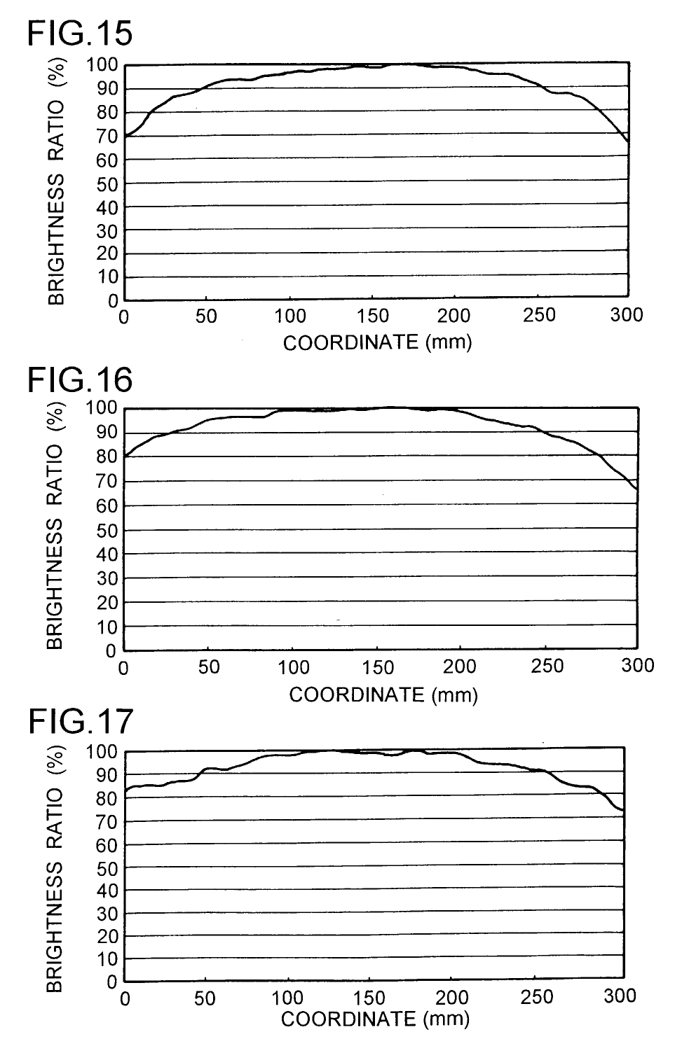

FIGS. 14 and 15 show the brightness distribution of the light emitted from the backlight 3, with one and another type, respectively, of diffuser sheet 7 additionally laid. FIGS. 16 and 17 show the brightness distribution of the emitted light under the same conditions as FIG. 14 but as observed from an oblique direction. In these diagrams, along the vertical axis is taken the brightness ratio (in %), and along the horizontal axis is taken the position (in mm) in the direction in which the fluorescent tubes 4a are arranged at intervals.

The liquid crystal panel 2 has a 20-inch size, and the backlight 3 is accordingly sized, with eight fluorescent tubes 4a (manufactured by Stanley Electric Co., Ltd., Japan, with an external diameter 26 mm) arranged at intervals “a”=38 mm. The substrate 8 is 5 mm thick, and the lenticular lenses 8d are arranged at intervals “d”=0.075 mm equal to their diameter. Used as the reflector sheet 5 is Lumirror™ E60L, manufactured by Toray Industries Inc., Japan, arranged at a distance “b”=16 mm (see FIG. 1) from the substrate 8.

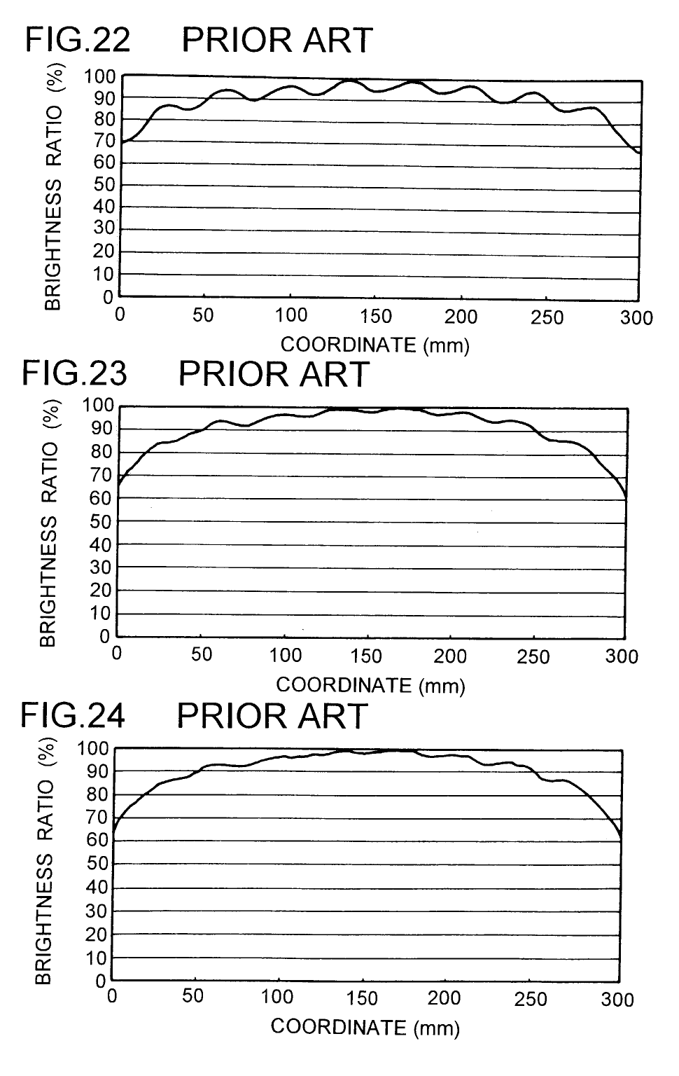

In FIG. 14, used as the diffuser sheet 7 is Light Up™ 100 PBS, manufactured by Kimoto & Co., Ltd., Japan. In FIG. 15, used as the diffuser sheet 7 is the same sheet as used in FIG. 14 but having Opalus™ #100-KBS II, manufactured by Keiwa Shoko Co., Ltd., Japan, laid on top thereof. Thus, the practical example under discussion, which yields the measurements shown in FIGS. 13 to 15, differs from the conventional example described earlier, which yields the measurements shown in FIGS. 22 to 24, only in that, here, the substrate 8 is provided in place of the diffuser plate 6 (see FIG. 21).

FIG. 12 shows that the light source 4 emits light that has markedly bright protons at the same intervals “a” at which the fluorescent tubes 4a are arranged. The light that has passed through the substrate 8 is made to diverge by the lens array 8a, and then travels forward. Thus, as shown in FIG. 13, the light from the light source 4 comes to have less uneven brightness. Eventually, as shown in FIGS. 14 and 15, the light, having passed through the substrate 8 and the diffuser sheet 7, comes to have acceptably small unevenness in brightness.

Here, while a comparison between FIG. 13 of the practical example and FIG. 22 of the conventional example indicates more uneven brightness in the practical example, a comparison between FIG. 15 of the practical example and FIG. 24 of the conventional example indicates less uneven brightness in the practical example. This is considered to prove that the light that is reflected from the diffuser sheet 7 and then re-exits from the substrate 8 as described earlier exerts much diffusing effects.

FIGS. 16 and 17 show the brightness distribution of the light emitted from the backlight 3 having the same structure as in FIG. 14, as observed when viewed from directions 30° and 60°, respectively, apart from a direction normal to the backlight 3. These diagrams show that the backlight 3 exhibits only small unevenness in brightness even when observed from an oblique direction. This helps enhance the image quality of the liquid crystal display device 1.

What is claimed is:

1. A backlight comprising:
a light source arranged face to face with an illuminated member;
a translucent substrate disposed between the light source and the illuminated member and having a lens array; and
a diffusive sheet disposed between the substrate and the illuminated member for diffusing light.

2. The backlight according to claim 1,
wherein the diffusive sheet has a haze value of 70% or higher.

3. The backlight according to claim 1,
wherein the lens array has lenticular lenses or hemispherical lenses arranged in an array.

4. The backlight according to claim 1,
wherein the lens array is formed on a surface of the substrate facing the illuminated member, and a surface of the substrate facing the light source is formed matte.

5. The backlight according to claim 1,
wherein the lens array is formed on both surfaces of the substrate.

6. The backlight according to claim 1,
wherein the substrate is 1 mm or more thick.

7. A liquid crystal display device comprising:
a backlight including a light source arranged face to face with an illuminated member, a translucent substrate disposed between the light source and the illuminated member and having a lens array, and a diffusive sheet disposed between the substrate and the illuminated member for diffusing light; and
a liquid crystal panel arranged with a light-receiving surface thereof located face to face with the light source of the backlight.
